(19) United States
(12) Patent Application Publication
(10) Pub. No.: US 2014/0358699 A1
(43) Pub. Date: Dec. 4, 2014

(54) SYSTEM AND METHOD FOR PROVIDING FREE REMOTE VISTUAL DESKTOP PAID FOR BY ADVERTISING OR OTHER COMMERCIAL CONTECT CO-DISPLAYED ON THE USER DESKTOP

(71) Applicant: MRK Networks, Inc., Allentown, PA (US)

(72) Inventor: Charles F. Buck, Kempton, PA (US)

(21) Appl. No.: 13/909,265

(22) Filed: Jun. 4, 2013

(51) Int. Cl. G06Q 30/02

(52) U.S. Cl. CPC G06Q 30/0277
USPC 705/14.73

(57) ABSTRACT

A system and method for providing free or low cost remote virtual desktop to a user display device from a remote display control device such as a computer server coupled to the global computer network and operating appropriate computer software. The virtual remote desktop occupies less than an entire display area on the user display device. The system and method also provides commercial sponsored content to the user display device. The commercial sponsored content is displayed adjacent the displayed virtual remote desktop. The commercial sponsored content may be content advertising goods or services and arbitrary or based on the user's remote virtual desktop or the users activity on the remote virtual desktop. The payment by third parties for the commercial sponsored content allows the provision of the free or low cost remote virtual desktop to the user.

### CROSS-REFERENCE TO RELATED APPLICATIONS

This application claims the benefit of U.S. Provisional Application Ser. No. 61/655,079 entitled “System And Method For Providing Advertising on Remote Desktops” filed Jun. 4, 2012, of which is incorporated fully herein by reference.

### TECHNICAL FIELD

The present invention relates to advertising methods and more particularly, relates to a system and method for providing advertising on remote desktops of cloud computing connected systems in order to pay for free remote desktop to the user.

### BACKGROUND INFORMATION

Cloud computing is fast becoming the standard of the future particularly for office environments. The benefits of cloud computing are many and well known.

Cloud computing is the delivery of computing as a service rather than as a product, whereby shared resources, software, and information are provided to computers and other devices as a utility (like the electricity grid) over a network (typically a global computer network such as the Internet).

Cloud computing entrusts, typically centralized services, with the user's data, software, and computation on a published application programming interface (API) over a network.

End users access cloud based applications through a web browser or a lightweight desktop or mobile application while the business software and data are stored on servers at a remote location. Cloud application providers strive to give the same or better service and performance than if the software programs were installed locally on end-user computers.

At the foundation of cloud computing is the broader concept of infrastructure convergence (or converged infrastructure) and shared services. This type of data center environment allows enterprises to get their applications up and running faster, with easier manageability and less maintenance, and enables the enterprise Information Technology department (IT) to more rapidly adjust IT resources (such as servers, storage, and networking) to meet fluctuating and unpredictable business demand.

To date, the use and deployment of cloud computing has been generally restricted to businesses or to an enterprise deployment. This is because of the cost typically associated with providing cloud computing services. It is clear however that individuals in a home, educational, home office or other similar setting could equally benefit from cloud computing services if the cost was affordable or perhaps even free. However, because of the present day pricing structure of cloud computing which relies on businesses and enterprises to pay for the entire cost of the service, providing such service to students, individuals and perhaps even small businesses has not been cost effective for the prospective end-users.

Accordingly, there is a need for a business model including a system and method that provides for a system and method of providing cloud computing services including, but not limited to remote virtual desktops to individuals, students and even small businesses at a reduced cost or perhaps at no cost.

### BRIEF DESCRIPTION OF THE DRAWINGS

These and other features and advantages of the present invention will be better understood by reading the following detailed description, taken together with the drawings wherein:

FIG. 1 is a block diagram of the system components and where they reside according to the present invention; and

FIG. 2 is a representation of a display device illustrating a sponsored content area in accordance with the teachings of the present invention.

### DETAILED DESCRIPTION OF THE PREFERRED EMBODIMENTS

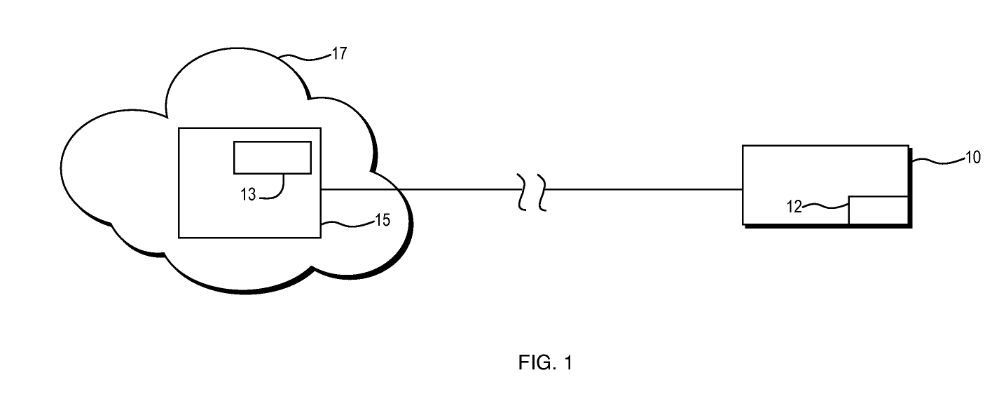

The present invention features a novel system and method of providing a sponsored content area 12, FIG. 1, on a display device 10 such as a computer monitor, computer tablet screen, mobile communication device or the like. The system and method of the present invention is controlled by an appropriate software component 13 which resides on a computer server or other similar remote desktop control device 15 located in or connected to the cloud (global computer network such as the internet) 17. The software component 13 allows the manager of this service to program and control the sponsored content area 12 including type, placement and the like as will be explained in greater detail below as well as the remote desktop content as required.

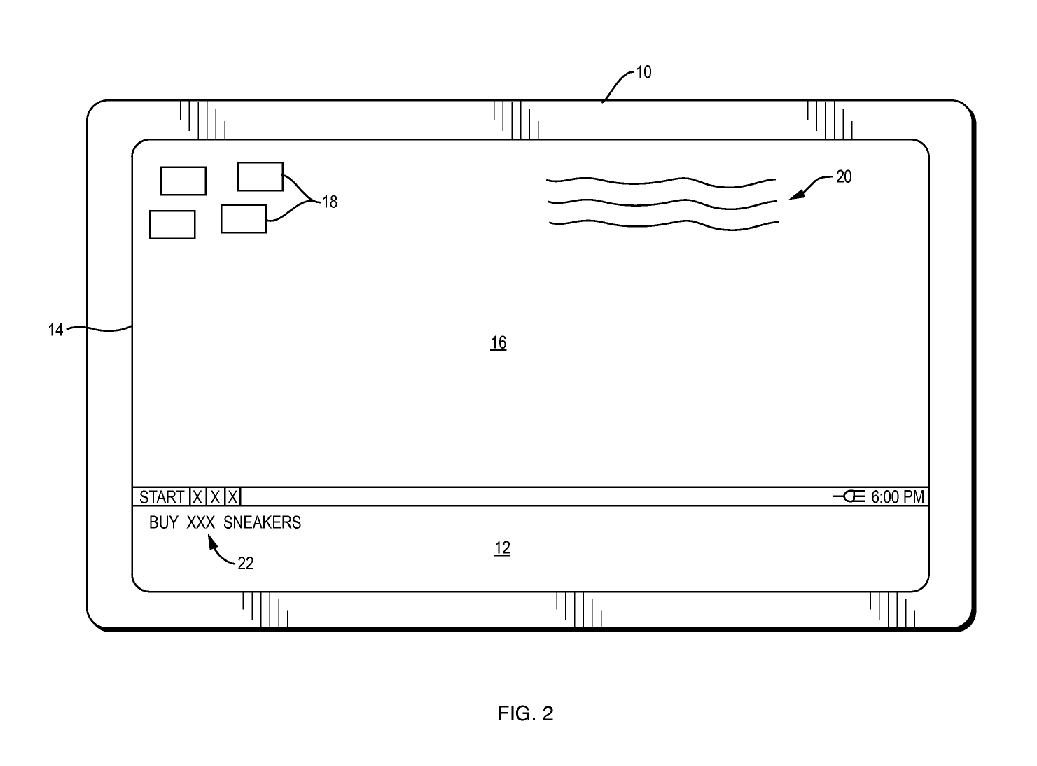

As shown in greater detail in FIG. 2, the display device 10 includes a display area 14 which is divided into a computing display area 16 and the sponsored content display area 12.

The computing display area 16 is typically referred to as a virtualized remote computer desktop for business or personal users. The computing display area 16 may display various program icons 18 or text or other information 20 the virtualized remote computer desktop is, as is well known in the art, provided by the presentation layer (layer 6) of the 7-layer OSI model of computer networking.

The virtualized remote desktop 16 may offer both commercial and open source applications. The virtualized remote desktop 16 will be vendor agnostic, utilizing any presently known or future developed layer-6 protocol to support desktop virtualization, including: Microsoft RDP; Citrix ICA; VMware PC-o-IP; VNC(open source); and X-windows)open source). In addition, the virtualized remote desktop 16 may utilize any known or future virtualization hypervisor for operating system virtualization including: VMware; X-en; Microsoft Hyper-V; and Virtual Box.

The computer display area 16 is illustrated as a Microsoft Windows virtualized remote desktop inside a web browser in full screen mode although this is not a limitation of the present invention as the virtualized remote desktop 16 may be a licensed Microsoft windows desktop instance, a licensed Apple operating system desktop instance, an open source Linux desktop, or any other virtualized desktop instance.

One feature of the present invention is providing the sponsored content display area 12 adjacent to the computing display area 16. The sponsored content display area 12 provides a third-party revenue stream permitting the virtualized remote computer desktop 16 to be offered at a reduced or low cost or perhaps even free of charge to the end user. The sponsored content 22 (there may be more than one sponsored content 22 contained within the sponsored content display area 12 at any one time) may consist of paid commercial advertising and/or consultation and customization offers from IT professionals or any other type of sponsored content.

The sponsored content may be the same for every virtual remote desktop user or alternatively, the content may be determined by the computer application types selected for use by the user. In another embodiment, the sponsored content 22 may be influenced and driven by the activity within the user's virtualized remote desktop 12. In yet another embodiment, the sponsored content 22 may be influenced and controlled by various algorithms including algorithms which passively evaluate activity on the virtualized remote desktop 16 and/or which utilize direct interaction from participants to choose the type and/or subject matter of the commercial content to be displayed.

In another embodiment, the sponsored content 22 may be chosen as a result of direct interaction (chat; voice; and or video) between virtual remote desktop users. The content may also be selected to provide mutual support (remote shadowing) between virtual remote desktop users and/or consultants which would be paid directly by the user. The sponsored content 22 may also be selected to provide contests using game like services and gamification algorithms to encourage the free virtual remote desktop usage.

The sponsored content area 12 may include sponsored content 22 that is passive, active, live, static and or interactive (interactive with other users). Passive content occurs when messages are displayed in simple graphic form to all users indiscriminately. Messages may be system notifications or simple advertising content. There will be no interaction between the user and this content.

With Active content, information is displayed in a specific portion of the content area intended to elicit a response from the user. This information is developed from demographic and system usage data specific to the user. With Live content, the display area contents changes in real time according to the current activity of the system user, while with Static content, a display area is reserved for logo and branding use for the provider, system reseller, and client company. Finally, Interactive content includes A display area reserved for interactive chat, voice, video, gaming, and social networking and other multi-party interactive content.

The sponsored content area 12 may be provided on any boundary (top, bottom, left or right) of the display device 10, at the user's option and control, but preferably cannot be resized or removed or “hidden”.

Accordingly, the present invention provides a system and method for providing a free or low cost user virtual remote desktop by including commercially supported sponsored content which appears in a sponsored content area on a user's virtual remote desktop. The commercially supported sponsored content may include goods or services that are decided upon independently by the system provider or alternatively, based on the users virtual desktop content in some manner

Modifications and substitutions by one of ordinary skill in the art are considered to be within the scope of the present invention, which is not to be limited except by the allowed claims and their legal equivalents.

The invention claimed is:

1. A method for providing a free user virtual remote desktop on a display device, said method comprising the acts of:
providing a computer server, coupled to a global computer network, said computer server operating appropriate computer server software configured for providing, to a display device, information to be displayed to a user;
providing, by said computer server, to a user display device having a display area, a virtual remote computer desktop, said virtual remote computer desktop displayed on said display device and occupying a first portion of said display area, said first portion of said display area occupying less than an entire display area of said display device; and
providing, to a second portion of said user display device display area, commercial sponsored content, said commercial sponsored content displayed in said second portion of said user display device display area adjacent said virtual remote computer desktop displayed on said display device.

2. The method of claim 1, wherein said provided virtual remote computer desktop is provided for free to said user.

3. The method of claim 1, wherein said second portion of said user display device display area displaying said commercial sponsored content can be located anywhere on said user display device under control of said user.

4. The method of claim 3, wherein said commercial sponsored content can be displayed in said second portion of said user display device display area in a display area that cannot be resized, closed or deleted.

5. A system for providing free user virtual remote desktop, said system comprising:
a remote desktop control device, for controlling the provision and displaying of at least a virtual remote computer desktop and commercial sponsored content to a user; and
a user display device, coupled to said remote desktop control device, said user display device having a display area, said remote desktop control device configured for displaying said virtual remote computer desktop on said display device, said virtual remote computer desktop displayed on a first portion of said display area of said display device, said first portion of said display area occupying less than an entire display area of said display device, and said remote display control device configured for providing, to a second portion of said user display device display area, commercial sponsored content, said commercial sponsored content displayed in said second portion of said user display device display area adjacent said virtual remote computer desktop displayed on said display device.

6. The system of claim 5 wherein said remote display control device is a computer server, coupled to a global computer network, said computer server operating appropriate computer server software configured for providing, to said display device, information to be displayed to a user in the form of said virtual remote computer desktop and said commercial sponsored content.

7. The system of claim 5, wherein said provided virtual remote computer desktop is provided for free to said user.

8. The system of claim 5, wherein said second portion of said user display device display area displaying said commercial sponsored content can be located anywhere on said user display device under control of said user.

9. The system of claim 8, wherein said commercial sponsored content can be displayed in said second portion of said user display device display area in a display area that cannot be resized, closed or deleted.
